(19) United States
(12) Patent Application Publication
(10) Pub. No.: US 2025/0242221 A1
(43) Pub. Date: Jul. 31, 2025

(54) MOBILE WATER SPORTS COURT

(71) Applicant: Peter Tatar, Budapest (HU)

(72) Inventor: Peter Tatar, Budapest (HU)

(21) Appl. No.: 19/103,903

(22) PCT Filed: Jul. 28, 2023
(86) PCT No.: PCT/HU2023/050046

§ 371 Date: Feb. 14, 2025

(30) Foreign Application Priority Data
Jul. 29, 2022 (HU) U2200109

(51) Int. Cl. A63B 67/00; A63B 71/02; A63C 19/08

(52) U.S. Cl. CPC A63B 67/007; A63B 71/021; A63B 71/023; A63C 19/08; A63B 2071/024; A63B 2210/50; A63B 2225/605; A63C 2019/085

(57) ABSTRACT

This invention relates to a mobile water sports court comprising a Net Module (3), a Line Module (2), and a Support Module (1). The Net Module (3) is positioned above the water surface and includes a Net Body (31), Upper and Lower Holder Cables (32, 33), and Sliding Hooks (34). The Line Module (2) is placed on the water surface and features Border Lines (20) with Marker-Holding Ropes (21) supporting cylindrical Boundary Markers (22), secured with Carabiners (23) and Corner Clips (24). The Support Module (1) includes Anchor Screws (11), Ground Screws (12), Guy Ropes (13a), Anchor Ropes (13b), Lower and Upper Support Pillars (14, 18), a Centerline (15) and Anchor Buoys (16), which connect the modules and secure the court. Additionally, a Pool Fixation Kit (10) with Threaded Anchor Plates (10a), Eye Bolts (10b), and Cushion Feet (10c, 10d) is provided for easy anchoring in pool environments, replacing traditional anchor methods. This modular structure offers stability, adaptability, and portability for water sports courts in both open water and pool settings.

### FIELD OF THE INVENTION

This invention pertains to a Mobile Water Sports Court (hereinafter referred to as the “MWSC” or “court”), which consists of a playing area divided by an aerial net and delineated by border lines on the surface of the water. All components are securely anchored to the waterbed using various fixing elements.

### BACKGROUND OF THE INVENTION

Traditional water sports courts are typically made of inflatable plastic fabrics and anchored in open water with heavy fastening elements. These courts generally lack adjustable court sizes or net heights, limiting flexibility for various sports. Installation can be complex, and accessing or exiting the court may be inconvenient. To withstand severe storms, they often need to be deflated and then reinflated before use. Additionally, their heavy fastening requirements make them unsuitable for pools.

### SUMMARY OF THE INVENTION

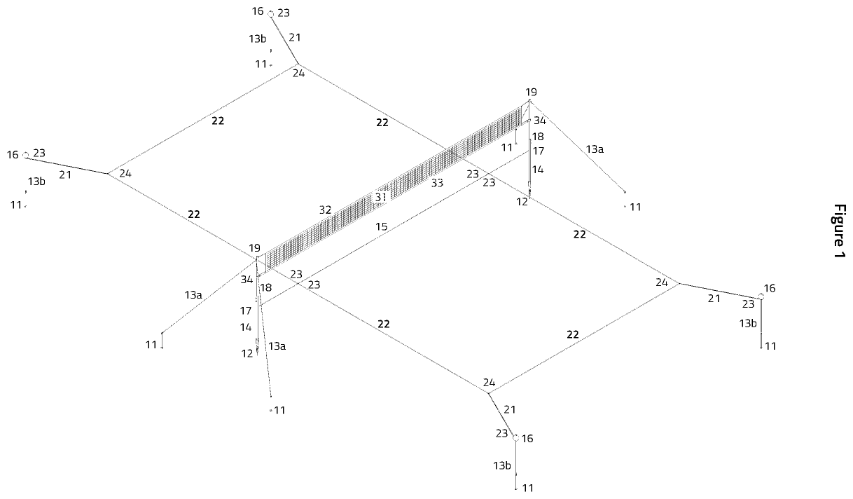

The MWSC features a robust net-holding and support system, called the Support Module (1), which is securely anchored to the waterbed using Ground Screws (12) and Anchor Screws (11), or, for pool installations, the Pool Fixation Kit (10). This system also includes a Net Module (3) positioned above the water and a Line Module (2) floating on it, both connected to specific sections of the Support Module (1) (see FIG. 1).

The playing area of the MWSC is rectangular and is divided longitudinally into two equal parts known as half-courts. The outer boundaries of each half-court are delineated at the water's surface by their respective Border Lines (20), while the shared boundary is marked by a Centerline (15), above which the Net Module (3) is suspended.

This invention introduces a versatile water sports court that adapts to multiple sports, including volleyball, badminton, beach tennis, and footnet. The court size and net height can be easily adjusted, allowing players to not only select their preferred sport but also tailor the playing conditions to the number and skill level of participants. Designed for teams of 1 to 6 players, the court is simple to set up and remove in both natural and artificial freshwater or saltwater environments, providing easy access to and from the playing area.

Unlike traditional monolithic courts that feature an all-in-one structure, the MWSC uses a modular design. Each module consists of simple, durable components that can be easily assembled, disassembled, and relocated by anyone with care, without requiring specialized training or equipment.

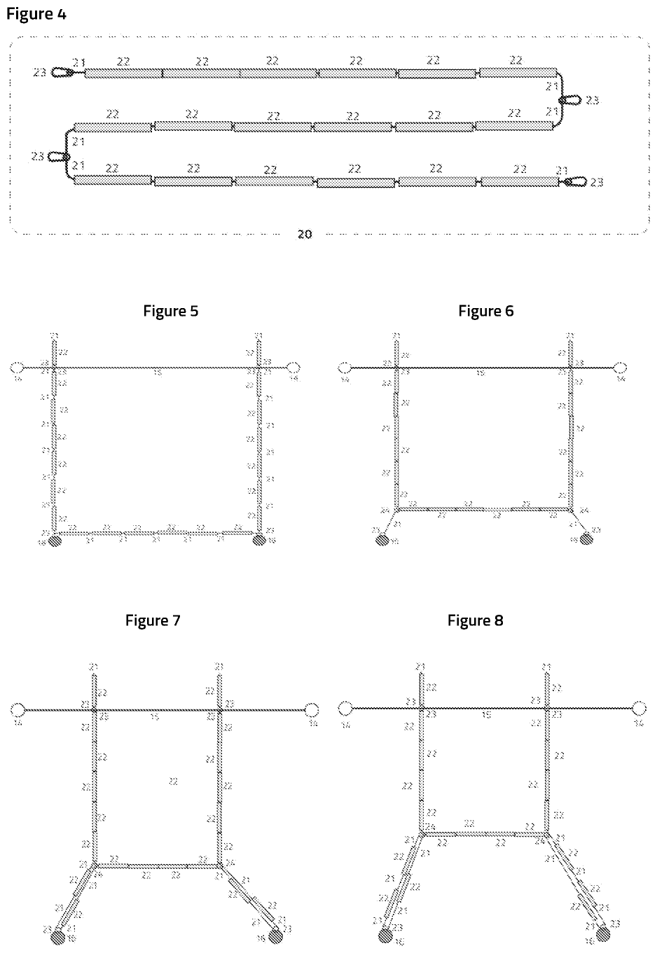

The inventive design of the Line Module (2) enables players to adjust the dimensions of each half-court without adding or removing components and ensures a clearly visible and dimensionally stable court layout, even in significant waves (see FIGS. 4, 5, 6, 7, and 8).

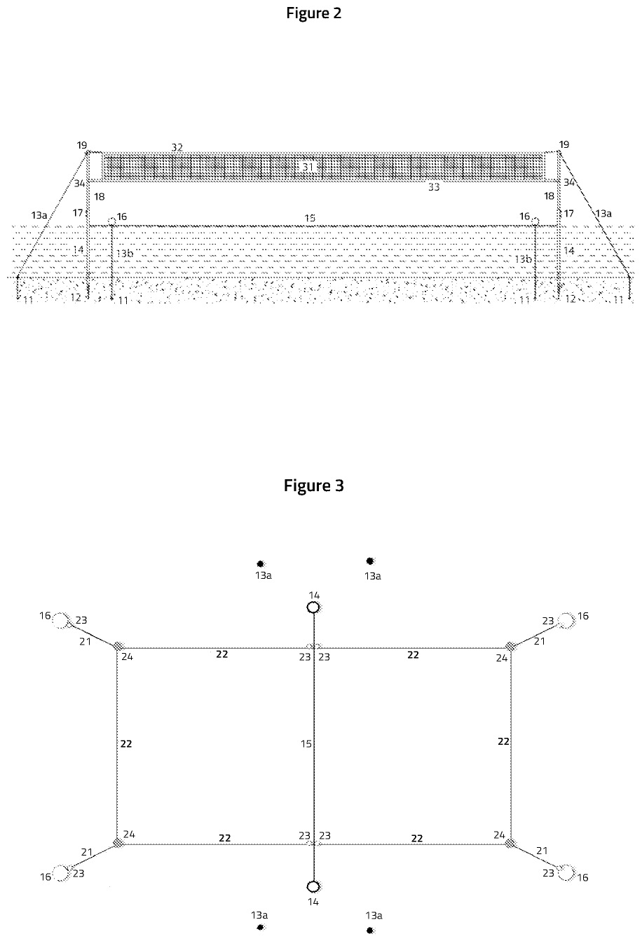

The net height can be adjusted in incremental steps due to the interlocking net Support Pillars (14, 18) and the Sliding Hook (34) of the Lower Holder Cable (33) (see FIG. 2).

The width of the Net Module (3) can be halved by raising the Sliding Hooks (34) on the Support Pillars (14, 18), which lifts the Lower Holder Cable (33) to the same level as the Upper Holder Cable (32). This reduces resistance against wind, waves, or debris during or after storms while maintaining the stability of the supporting structure of the court.

Both the Line Module (2) and Net Module (3) are designed to withstand moderate storms. However, in severe conditions, they can be quickly removed and securely stored due to their portable design. This leaves only a few components of the Support Module (1) (10a, 11) in the water, minimizing the resistance of the remaining parts to natural forces or debris.

Most components of the MWSC are well-known end products, and as such, their parts, structure, and the methods for creating releasable connections are assumed to be state of the art unless otherwise specified. All connections between the components of the court are releasable, allowing each part to be removed, repaired, or replaced as needed. The fixing elements of the Support Module (1) can be repeatedly driven into or removed from the waterbed, with the exception of the Pool Anchor Plate (10a), which must be securely adhered to the pool floor.

In the drawings:

FIG. 1 is a comprehensive overview of the court displaying all elements.

FIG. 2 displays the components of the Support (1), Line (2), and Net (3) modules in three different environments: soil, water, and air, along with their connections, whereas FIG. 3 depicts the elements of the Support Module (1) and the Line Module (2) as they appear on the water surface.

FIG. 4 illustrates the structure of the Border Lines (20), while FIGS. 6 to 8 demonstrate various half-court sizes using the Corner Clips (24).

FIG. 5 depicts an ‘unofficial’ half-court configuration where no Corner Clips (24) are used, resulting in sidelines and the baseline that are not precisely measurable.

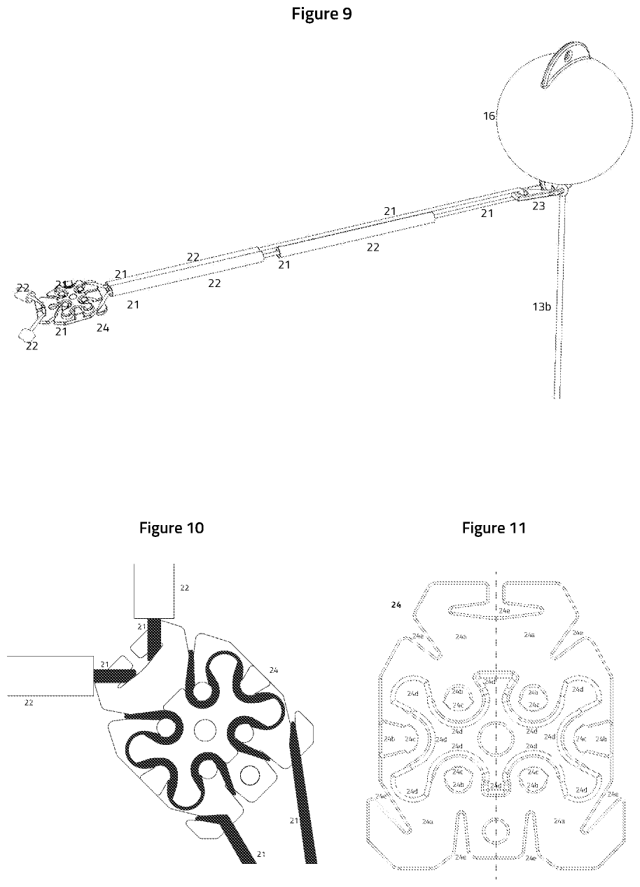

FIG. 9 is an enlarged image of the lower left third of FIG. 8, intended to illustrate the connection between the Line Module (2) and the Support Module (1) at one corner of the court.

FIG. 10 is an enlarged image of the lower left-hand corner of FIG. 9, intended to illustrate the detachable connection between the Corner Clip (24) and the Marker-Holding Rope (21).

FIG. 11 is an enlarged image of the middle of FIG. 10, illustrating the functional parts of a Corner Clip (24).

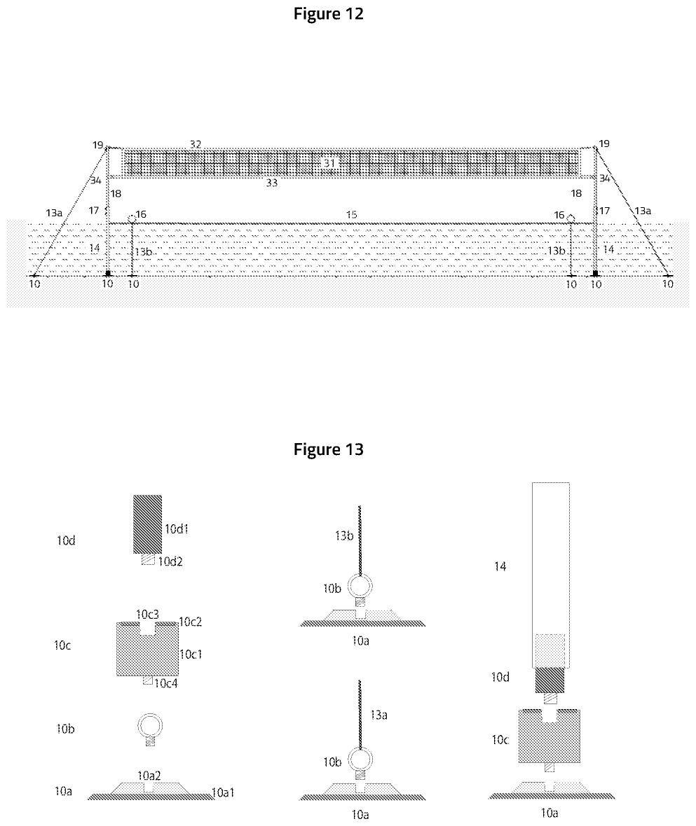

FIG. 12 presents the components of the Support (1), Line (2), and Net (3) modules as installed in a pool.

FIG. 13 illustrates the elements of the Pool Fixation Kit (10a, 10b, 10c, 10d) along with their components.

The modules of the invention are not shown directly in the drawings; instead, their components are depicted. Elements with reference numbers between 10 and 19 are part of the Support Module (1), those between 20 and 24 belong to the Line Module (2), and those between 31 and 34 are associated with the Net Module (3).

### DETAILED DESCRIPTION OF THE INVENTION

The Mobile Water Sports Court is anchored to the waterbed using eight Anchor Screws (11) and two Ground Screws (12). Two Lower Support Pillars (14) are inserted into the Ground Screws (12) and secured with gripping screws, allowing for releasable connections. The Upper Support Pillars (18) are then placed into the Lower Support Pillars (14) and fastened with Locking Screws (17), providing adjustable connections. Each Upper Support Pillar (18) has a double-sided Hanging Hook (19) at the top, secured with releasable fastenings, and a Sliding Hook (34) to accommodate the Upper Holder Cable (32) and Lower Holder Cable (33) of the Net Module (3), respectively.

The Net Module (3) consists of a Net Body (31) secured by the Upper and Lower Holder Cables (32, 33). The Upper Holder Cable (32) attaches to the inner part of the Hanging Hooks (19) on the Upper Support Pillars (18), while the Lower Holder Cable (33) connects to Sliding Hooks (34), allowing for vertical adjustment along the Support Pillars (14, 18). To stabilize the Net Module (3) and maintain proper net tension, four Guy Ropes (13a) secure the outer side of the Hanging Hooks (19) on the Upper Support Pillars (18) to a pair of Anchor Screws (11) per Lower Support Pillar (14). These evenly spaced Anchor Screws (11) are driven deep into the waterbed, providing stable attachment points.

The net height can be adjusted incrementally due to the interlocking Support Pillars (14, 18) and the Sliding Hooks (34) of the Lower Holder Cable (33). Additionally, the width of the Net Module (3) can be halved by raising the Sliding Hooks (34) on the Support Pillars (14, 18), lifting the Lower Holder Cable (33) to the same level as the Upper Holder Cable (32).

This configuration of the Support Module (1) and Net Module (3) ensures the court's structural integrity by maintaining proper tension in both the Lower (14) and Upper (18) Support Pillars, and by preserving the stability and tautness of the Net Module (3), which can be heavily impacted during play or by weather conditions (see FIGS. 2 and 12).

At each corner of the court, additional Anchor Screws (11) are driven deep into the waterbed to secure Anchor Buoys (16), which float above them and are connected by fixed or flexible Anchor Ropes (13b) (see FIGS. 2, 3, and 9). The Border Lines (20) are fastened to the Anchor Buoys (16) and the Centerline (15), which is positioned between the Lower Support Pillars (14), using Carabiners (23). This setup ensures that the Line Module (2) remains securely in place, staying precisely centered beneath the Net Module (3) at the water's surface (see FIG. 3).

Each Border Line (20) consists of a Marker-Holding Rope (21) equipped with releasable Carabiners (23) at both ends, as well as at one-third and two-thirds of its length. Fixed-size cylindrical Boundary Markers (22), designed with either a central hole or an outer groove, are threaded onto the Marker-Holding Rope (21) between the Carabiners (23), ensuring even distribution along the rope (see FIG. 4).

Corner Clips (24) on the Border Lines (20) mark the rear corners of each half-court, with the front corners defined by the attachment points of the front Carabiners (23) on the Centerline (15). The Corner Clips (24) are threaded onto the Marker-Holding Rope (21) at points between selected Boundary Markers (22), dividing the Border Lines (20) into five sections.

Section 1, between the first Carabiner (23) and first Corner Clip (24), forms one sideline. Section 2, between the two Corner Clips (24), forms the baseline. Section 3, between the second Corner Clip (24) and second Carabiner (23), forms the opposite sideline. Sections 4 and 5, between the Corner Clips (24) and Carabiners (23) on the Anchor Buoys (16), extend beyond the half-court and are not part of the playing area. By mirroring this setup for the other half-court, the full playing area of the MWSC is established (see FIGS. 5, 6, 7, 8 and 9).

Each Corner Clip (24) must have at least four fastening elements, with the Marker-Holding Rope (21) secured to at least two. Each fastening element consists of a Central Body (24b) and a Surrounding Surface (24d) that partially encircles it, extending from the Base Plate (24a). The Central Body (24b) should have Roughened Surfaces (24c) facing the Surrounding Surface (24d), and the Corner Clips (24) should include Lacing Grooves (24e) in the Base Plate (24a) for the Marker-Holding Rope (21). For optimal security, the Marker-Holding Rope (21) should be threaded through all Lacing Grooves (24e), fitting between the Roughened (24c) and Surrounding (24d) Surfaces of each fastening element (see FIGS. 10 and 11).

The Pool Fixation Kit (10) consists of components (10a, 10b, 10c, 10d) designed to anchor the water sports court to the pool floor, replacing the Anchor Screws (11) and Ground Screws (12) used in open water. It provides a stable foundation for the court while enabling easy removal and reinstallation through releasable connections. In total, eight Threaded Anchor Plates (10a) are adhered to the pool floor, with Eye Bolts (10b) serving as attachment points for the Guy Ropes (13a) and Anchor Ropes (13b). Two additional Threaded Anchor Plates (10a) serve as attachment points for the Lower Support Pillars (14), which are secured with the Lower Cushion Foot (10c) and Upper Cushion Foot (10d), providing both shock-absorbing stability and ease of removal (see FIG. 12).

The Threaded Anchor Plate (10a) has a base (10a1) with safety edges, designed to adhere to the pool floor. It features a threaded hole or insert (10a2) for securing screws, ensuring a stable foundation. Guy Ropes (13a) and Anchor Ropes (13b) attach via the Eye Bolts (10b), while the Lower Support Pillars (14) are secured with the Lower Cushion Foot (10c) and Upper Cushion Foot (10d) (see FIG. 13).

The Lower Cushion Foot (10c) is part of the shock-absorbing system designed to stabilize and cushion the Lower Support Pillars (14). It consists of a rubber cylinder (10c1) with a metal plate (10c2) on top, extending beyond the width of the Lower Support Pillar (14). It features a threaded insert (10c3) at the top and a built-in screw (10c4) at the bottom, securing it to the threaded hole (10a2) of the Threaded Anchor Plate (10a). The Upper Cushion Foot (10d) is the upper part of the shock-absorbing system, designed to fit into the Lower Support Pillar (14). It consists of a rubber cylinder (10d1) with a built-in screw (10d2) at the bottom, which threads into the threaded insert (10c3) of the Lower Cushion Foot (10c). This creates a loose connection with the Lower Support Pillar (14), helping to absorb shocks from the Net (3) and Support Module (1), ensuring stability while maintaining flexibility for reinstallation (see FIG. 13).

### List of Components

The following table provides a comprehensive list of MWSC components, organized by reference sign (REF) as shown in the drawings section and by the terminology (NAME) used in the text of this application. The components are categorized by module (MODULE) and may include additional relevant information (NOTE).

| REF | NAME | MODULE | NOTE |
|---|---|---|---|
| 1 | Support Module | Support | A name for the joint reference of the components used to fix the elements |
| | | | of the court to the water bed or the pool floor and to hold and support the |
| | | | net (3) and Line Module (2) |
| 2 | Line Module | Line | A term used to collectively name the 2 pcs of Border Lines (20) and their |
| | | | components |
| 3 | Net Module | Net | The name used to refer to the aerial net and its components together |
| 10 | Pool Fixation | Support | The Pool Fixation Kit is a set of components designed to anchor the water |
| | Kit | | sports court to the pool floor, replacing the Anchor Screws (11) and Ground |
| | | | Screws (12) used in open water |
| 10a | Threaded | Support | A base (10a1) with safety edges, designed to be adhered to the pool floor. It |
| | Anchor Plate | | features a threaded hole or insert (10a2) for securing screws, ensuring a |
| | | | stable foundation for anchoring the court's components |
| 10b | Eye Bolt | Support | A bolt with a circular eye-shaped loop at one end, used to secure ropes or |
| | | | cables |
| 10c | Lower Cushion | Support | The lower part of the shock-absorbing system, designed to stabilize and |
| | Foot | | cushion the Lower Support Pillars (14) in a pool |
| 10d | Upper Cushion | Support | The upper part of the shock-absorbing system, designed to fit into the |
| | Foot | | Lower Support Pillar (14), thereby forming a loose, impact-dampening |
| | | | connection with it |
| 11 | Anchor Screws | Support | The underwater attachment points of the Guy Ropes (13a) and the Anchor |
| | | | Ropes (13b) to the lakebed or seabed |
| 12 | Ground Screws | Support | The underwater fastening elements of the Lower Support Pillars (14) to the |
| | | | lakebed or seabed |
| 13a | Guy Ropes | Support | Adjustable fixed ropes that secure and reinforce the connection between |
| | | | the Anchor Screws (11) or Eye Bolts (10b) of the Threaded Anchor Plates |
| | | | (10a) and the Hanging Hooks (19) on the Upper Support Pillars |
| 13b | Anchor Ropes | Support | Fixed or flexible ropes that secure and reinforce the connection between |
| | | | the Anchor Screws (11) or Eye Bolts (10b) of the Threaded Anchor Plates |
| | | | (10a) and the Anchor Buoys (16) |
| 14 | Lower Support | Support | Components that enclose the Upper Support Pillars (18), secure the |
| | Pillars | | Centerline (15), and extend beneath the water to anchor either into the |
| | | | Ground Screws (12) in the lakebed or seabed, or onto the Lower Cushion |
| | | | Feet (10c), while enclosing the Upper Cushion Feet (10d) |
| 15 | Centerline | Support | A flexible rope stretched between the two Lower Support Pillars (14) at the |
| | | | water level, helping to keep the Line Module (2) afloat |
| 16 | Anchor Buoys | Support | Components that help keep the Line Module (2) afloat and secured to the |
| | | | Anchor Screws (11) in the lakebed or seabed, or to the Eye Bolts (10b) of |
| | | | the Threaded Anchor Plates (10a) in pools, via Anchor Ropes (13b) |
| 17 | Locking Screws | Support | Components for fine-tuning the net height by fixing the sliding of the Upper |
| | | | Support Pillars (18) into the Lower Support Pillars (14) |
| 18 | Upper Support | Support | Components inserted into the Lower Support Pillars (14) that hold the Net |
| | Pillars | | Module (3) by attaching the upper holder cable (32) to Hanging Hooks (19) |
| | | | fitted into them and the Lower Holder Cable (33) to Sliding Hooks (34) |
| | | | threaded onto them |
| 19 | Hanging Hooks | Support | Double-sided components fitted into the Upper Support Pillars (18), where |
| | | | an inner hook securing the upper holder cable (32) and an outer hook can be |
| | | | connected to Anchor Screws (11) or to Eye Bolts (10b) |
| 20 | Border Lines | Line | Collective name for the components used to hold and display a half-court |
| 21 | Marker-Holding | Line | A flexible or fixed rope used to support and position the Boundary Markers |
| | Rope | | (22) on the water surface, clearly delineating the edges of the play area. It |
| | | | serves as a structural element to hold the Boundary Markers (22) in place |
| 22 | Boundary | Line | Fixed-size cylindrical Boundary Markers (22), featuring either a central hole |
| | Markers | | or an outer groove, make the half-court boundary visible on the water |
| | | | surface when threaded onto the Marker-Holding Rope (21) |
| 23 | Carabiners | Line | Quick-connect components used to secure the half-courts in place by |
| | | | attaching the Border Lines (20) to the Centerline (15) and to the Anchor |
| | | | Ropes (13b), allowing for both fast connection and removal |
| 24 | Corner Clips | Line | Components used to define the half-court by securing the Boundary |
| | | | Markers (22) on the Marker-Holding Rope (21) at specific points along the |
| | | | Border Line (20) |
| 31 | Net Body | Net | An element used to display the spatial boundaries between the two half- |
| | | | courts in the air |
| 32 | Upper holder | Net | An element that supports the entire Net Body (31), defining the space in the |
| | cable | | air |
| 33 | Lower Holder | Net | An element used to tension the Net Body (31), ensuring it stays taut and |
| | Cable | | maintains its shape |
| 34 | Sliding Hooks | Net | Components that allow the ends of the Lower Holder Cable (33) to be |
| | | | fastened and slid along the Upper Support Pillars (18), enabling precise |
| | | | adjustment of the Net Module (3) position |

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A mobile water sports court comprising a Net Module (3) arranged above the water surface; a Line Module (2) arranged on the water surface; and a Support Module (1) with fixing elements secured to the waterbed and additional elements connecting the Line Module (2) and the Net Module (3) to the fixing elements; wherein the Net Module (3) includes Net Module (3) includes a Net Body (31), Upper Holder Cable (32), Lower Holder Cable (33), and Sliding Hooks (34); the Line Module (2) includes two Border Lines (20), each with a Marker-Holding Rope (21) serving as a framework for fixed-size cylindrical Boundary Markers (22) featuring either a central hole or an outer groove, along with Carabiners (23) and Corner Clips (24); the Support Module (1) comprises at least eight Anchor Screws (11), two Ground Screws (12), at least four Guy Ropes (13a), four Anchor Ropes (13b), two Lower Support Pillars (14), a Centerline (15) fixed between the Lower Support Pillars (14), four Anchor Buoys (16), at least four Locking Screws (17), and two Upper Support Pillars (18) with double-sided Hanging Hooks (19) secured with screws; wherein the Lower Support Pillars (14) are inserted into the Ground Screws (12) and secured with gripping screws; the Upper Support Pillars (18) are placed into the Lower Support Pillars (14) and fastened with Locking Screws (17); four Guy Ropes (13a) secure the outer side of the Hanging Hooks (19) on the Upper Support Pillars (18) to the Anchor Screws (11) evenly spaced from the Lower Support Pillars (14); each corner of the court has one Anchor Screw (11) connected by a fixed or flexible Anchor Rope (13b) to an Anchor Buoy (16) floating above it; and the Net Body (31) is secured by the Upper and Lower Holder Cables (32, 33), wherein the Upper Holder Cable (32) is attached to the inner part of the Hanging Hooks (19) on the Upper Support Pillars (18), and the Lower Holder Cable (33) connects to the Sliding Hooks (34) moved onto the Upper Support Pillars (18).

2. The mobile water sports court according to claim 1, wherein the fixed or flexible Marker-Holding Ropes (21) enclosed by Boundary Markers (22) forming the Border Line (20) are arranged along the sides of the rectangle and fastened to the Anchor Buoys (16) and the Centerline (15) using respective Carabiners (23).

3. The mobile water sports court according to claim 1, wherein a section of the Marker-Holding Rope (21) between two Carabiners (23), and a section between a Carabiner (23) and the Centerline (15), is clamped by a Corner Clip (24).

4. The mobile water sports court according to claim 3, wherein the Corner Clip (24) is formed from a Base Plate (24a) and fastening elements protruding from the Base Plate (24a), with the fastening elements arranged symmetrically along the longitudinal axis of the Base Plate (24a).

5. The mobile water sports court according to claim 4, wherein at least four fastening elements of the Corner Clip (24) are formed on the Base Plate (24a), and a section of the Marker-Holding Rope (21) is secured to at least two of the fastening elements.

6. The mobile water sports court according to claim 5, wherein each fastening element comprises a Central Body (24b) and a Surrounding Surface (24d) that partially encircles the Central Body (24b), both extending from the Base Plate (24a).

7. The mobile water sports court according to claim 6, wherein roughened surfaces (24c) are on the Central Body (24b) facing the Surrounding Surface (24d), and Lacing Grooves (24e) are formed on the Base Plate (24a).

8. The mobile water sports court according to claims 1 and 2, wherein the Pool Fixation Kit (10) consists of components designed to anchor the water sports court to the pool floor, replacing the Anchor Screws (11) and Ground Screws (12) used in open water, comprising at least eight Threaded Anchor Plates (10a) adhered to the pool floor, with at least eight Eye Bolts (10b) serving as attachment points for the Guy Ropes (13a) and Anchor Ropes (13b); and two additional Threaded Anchor Plates (10a) serve as attachment points for the Lower Support Pillars (14), which are secured with the Lower Cushion Feet (10c) and Upper Cushion Feet (10d).

9. The mobile water sports court according to claim 8, wherein a Threaded Anchor Plate (10a) has a Base (10a1) with safety edges, securely adhered to the pool floor, and featuring a Threaded Hole or Insert (10a2) for securing screws.

10. The mobile water sports court according to claims 8 and 9, wherein the Lower Cushion Foot (10c) is the lower part of the shock-absorbing system designed to stabilize and cushion the Lower Support Pillars (14), comprising a Rubber Cylinder (10c1) with a Metal Plate (10c2) on top, extending beyond the width of the Lower Support Pillar (14), with a Threaded Hole or Insert (10c3) at the top and a Built-In Screw (10c4) at the bottom, attaching it securely to the Threaded Hole or Insert (10a2) of the Threaded Anchor Plate (10a).

11. The mobile water sports court according to claims 8, 9, and 10, wherein the Upper Cushion Foot (10d) is the upper part of the shock-absorbing system, designed to fit into the Lower Support Pillar (14), creating a loose connection with it, and consists of a Rubber Cylinder (10d1) with a Built-In Screw (10d2) at the bottom, which threads into the Threaded Hole or Insert (10c3) of the Lower Cushion Foot (10c).
